(19) United States
(12) Patent Application Publication
(10) Pub. No.: US 2011/0298977 A1
(43) Pub. Date: Dec. 8, 2011

(54) VIDEO PROCESSING DEVICE

(75) Inventor: Yuji SEKIGUCHI, Nara (JP)

(73) Assignee: PANASONIC CORPORATION, Osaka (JP)

(21) Appl. No.: 13/208,858

(22) Filed: Aug. 12, 2011

Related U.S. Application Data
(63) Continuation of application No. PCT/JP2009/003777, filed on Aug. 6, 2009.

(30) Foreign Application Priority Data
Feb. 12, 2009 (JP) 2009-029489

(51) Int. Cl. H04N 7/01

(52) U.S. Cl. 348/448; 348/E07.003

(57) ABSTRACT

A video processing device for converting an interlaced signal into a progressive signal includes an OSD mixer which mixes an OSD display, such as a caption or a telop, with the interlaced signal, a cinema detector which detects a pulldown pattern by comparing video images of different fields, a phase comparator which compares a timing of change in the OSD display and a timing of change in a cinema video image based on OSD mixing signals indicating OSD-mixed locations in the OSD mixer and on the pulldown pattern detected in the cinema detector, and an interpolated pixel generator which generates a new pixel between lines of the interlaced signal by an interpolation method based on a detection result in the cinema detector and on a comparison result in the phase comparator.

### CROSS-REFERENCE TO RELATED APPLICATION

This is a continuation of PCT International Application PCT/JP2009/003777 filed on Aug. 6, 2009, which claims priority to Japanese Patent Application No. 2009-029489 filed on Feb. 12, 2009. The disclosures of these applications including the specifications, the drawings, and the claims are hereby incorporated by reference in its entirety.

### BACKGROUND

The present disclosure relates to devices for converting interlaced signals into progressive signals, and more particularly to video processing devices capable of preventing video image disturbances and thus capable of performing IP conversion providing high image quality when on-screen display (OSD) information, such as text superimposed on the screen (also referred to as caption or scrolling ticker, or telop), is mixed with telecine video. As used herein, the term “mix” and the term “superimpose” may be used interchangeably, and may generally refer to combining multiple streams of graphical data whether still or video.

As television sets have less thicknesses and larger sizes, video devices which interpolate scan lines of an interlaced signal and provide conversion into a progressive signal (IP conversion) before displaying are becoming popular. Various methods exist as IP conversion techniques. In recent years, motion adaptive IP conversion has been used, in which movement in a video image is detected using a difference between video images of different fields, and a video image of an interpolation line is interpolated using pixels in the same field (intra-field interpolation) as shown in FIG. 4 for pixels detected to have moved, while interpolation is performed using video images of different fields (inter-field interpolation) as shown in FIG. 5 for pixels detected to be unmoved.

In addition, conversion of a cinema signal, such as that of motion picture film, into a video signal, such as that of television or a digital versatile disc (DVD) (conversion into telecine video) is performed using a 2:3 pulldown process for NTSC video, and using a 2:2 pulldown process for PAL video. When IP conversion is performed on such telecine video, ideal progressive video can be generated by detecting the pattern of the pulldown conversion (cinema detection) and by using a video image of a field corresponding to the pulldown pattern for an interpolation line.

Mixing a video image not having the pattern of pulldown conversion, such as a caption, with telecine video causes the image quality at the location of the caption to be reduced. Describing using FIG. 6, mixing the caption #2 with the telecine video #1, and subsequently performing IP conversion on the generated video #3 according to the pulldown pattern cause the image quality to be reduced at the location of the caption as #4.

Thus, as shown in FIG. 7, a technique has been proposed in which a timing of change in a video image is detected from the pulldown pattern of the telecine video, and if the timing of caption insertion and the timing of change in the video image are not synchronous, then IP conversion utilizing the pulldown pattern is performed using a video image in which the timing of change in the video image and the timing of change in the caption are synchronized by mixing a delayed caption with the video image, and accordingly reduction in image quality is prevented when a caption is inserted into telecine video (Japanese Patent Publication No. 2001-339637 (FIG. 1)).

### SUMMARY

However, when an OSD having a video image which moves every frame, such as a telop, is inserted, the aforementioned method performs OSD mixing only on a caption which changes in synchronism with the timing of change in a video image based on the pulldown pattern, and thus no OSD mixing is performed on a telop which changes out of synchronism with the timing of change in the video image, thereby causing the image quality to be reduced. For example, in FIG. 7, mixing the telop #2 with the telecine video #1 in the way described above causes the telop #2-1, #2-4, and #2-6 to be mixed, and the mixed video is as shown in #5. In this case, no OSD mixing is performed on the telop #2-2, #2-3, #2-5, #2-7, and #2-8, and thus the image quality of the telop is reduced.

A video processing device for converting an interlaced signal into a progressive signal includes an OSD mixer configured to mix an OSD display with the interlaced signal, a cinema detector configured to detect a pulldown pattern by comparing video images of different fields, a phase comparator configured to compare a timing of change in the OSD display and a timing of change in a cinema video image based on an OSD mixing signal indicating an OSD-mixed location in the OSD mixer and on the pulldown pattern detected in the cinema detector, and an interpolated pixel generator configured to generate a new pixel between lines of the interlaced signal by an interpolation method based on a detection result in the cinema detector and on a comparison result in the phase comparator.

According to the present invention, since movement of the OSD-mixed location is detected and intra-field interpolation is applied to the location of movement, reduction in image quality is prevented when IP conversion is performed on video in which a changing OSD, such as a telop, is mixed with telecine video.

### BRIEF DESCRIPTION OF THE DRAWINGS

FIG. 1 is a block diagram illustrating a configuration of a video processing device according to the first embodiment.

FIG. 2 is a table illustrating relationships among delay combinations of video selected as interpolation lines based on the pulldown pattern detected by the cinema detector, results of the OSD mixing signals, and output results of the phase comparator.

FIG. 3 is a block diagram illustrating a configuration of a video processing device according to the second embodiment.

FIG. 4 is a conceptual diagram of pixel generation by intra-field interpolation.

FIG. 5 is a conceptual diagram of pixel generation by inter-field interpolation.

FIG. 6 is a conceptual diagram illustrating an example when a caption is mixed with a 3:2 pulldown video image.

FIG. 7 is a conceptual diagram illustrating an example when a caption is mixed with a 3:2 pulldown video image so that the timing of change in the 3:2 pulldown video image and the timing of caption insertion are synchronized.

### DETAILED DESCRIPTION

The video processing devices according to the various embodiments of the present invention are each a video processing device for converting an interlaced signal into a progressive signal, and it is preferable that each of the video processing devices include an OSD mixer configured to mix an OSD display with the interlaced signal, a cinema detector configured to detect a pulldown pattern by comparing video images of different fields, a phase comparator configured to compare a timing of change in the OSD display and a timing of change in a cinema video image based on an OSD mixing signal indicating an OSD-mixed location in the OSD mixer and on the pulldown pattern detected in the cinema detector, and an interpolated pixel generator configured to generate a new pixel between lines of the interlaced signal by an interpolation method based on a detection result in the cinema detector and on a comparison result in the phase comparator. With this configuration, reduction in video quality is prevented at an OSD-mixed location when the timing of movement of the OSD-mixed video does not follow the pulldown pattern of input video.

The interpolated pixel generator includes, for example, an intra-field interpolator configured to generate a pixel of an interpolation line from pixel data of a same field, an inter-field data selector configured to select a pixel of another field based on pulldown information, which is the detection result in the cinema detector, and an interpolation data selector configured to select an output result of the intra-field interpolator or a selection result of the inter-field data selector.

In addition, the phase comparator includes, for example, an OSD movement detector configured to detect movement of an OSD by making a comparison with an OSD mixing signal having a different field delay by at least one field, and a motion detector configured to investigate a difference between video images of fields different by at least one field from each other at a location where the OSD movement detector determines that the OSD-mixed location has not moved.

Moreover, the cinema detector excludes the OSD-mixed location from cinema detection, and thereby allowing the accuracy of cinema detection to be improved.

Specific embodiments of video processing devices according to the present invention will be described below.

### First Embodiment

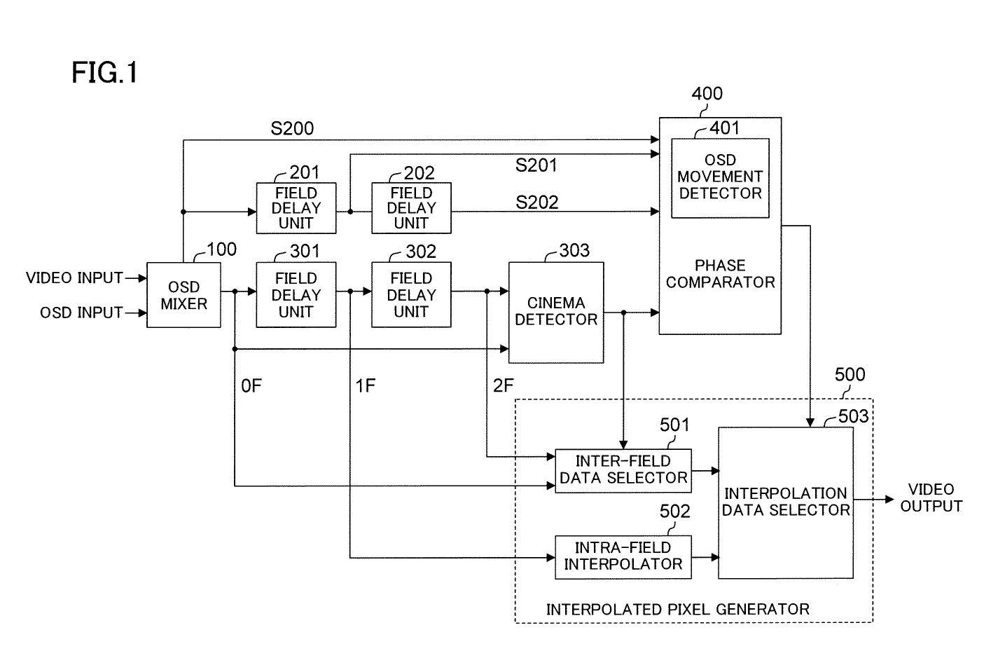

FIG. 1 is a block diagram illustrating a configuration of a video processing device according to the first embodiment. The video processing device includes an OSD mixer 100, field delay units 201, 202, 301, and 302, a cinema detector 303, a phase comparator 400, and an interpolated pixel generator 500.

The OSD mixer 100 mixes an OSD input with an interlaced signal of a video input at a mix ratio α. The mix ratio α represents a ratio of the OSD input to the output video, and can be expressed as “output video=α OSD input+(1−α)·input video.”

The OSD mixer 100 outputs a video signal OF, which is obtained by mixing the OSD with the input video at locations where a is greater than zero. In addition, the OSD mixer 100 outputs an OSD mixing signal S200 representing pixels where the mix ratio α is greater than zero, and an OSD has been mixed (or superimposed). It is assumed that the setting of OSD mixing can be set to any value greater than or equal to an OSD mix ratio.

The field delay unit 201 outputs an OSD mixing signal S201, which is delayed for one field with respect to the OSD mixing signal S200 output from the OSD mixer 100. The field delay unit 202 outputs an OSD mixing signal S202, which is delayed for one field with respect to the OSD mixing signal S201 output from the field delay unit 201. That is, the OSD mixing signal S202 is delayed for two fields with respect to the OSD mixing signal S200 output from the OSD mixer 100.

The field delay unit 301 outputs a video signal 1F, which is delayed for one field with respect to the video signal OF output from the OSD mixer 100. The field delay unit 302 outputs a video signal 2F, which is delayed for one field with respect to the video signal 1F output from the field delay unit 301. That is, the video signal 2F is delayed for two fields with respect to the video signal OF output from the OSD mixer 100.

The cinema detector 303 detects the pulldown pattern of the input video, using video images of different fields. For example, if the input video has a 3:2 pulldown format, the regularity in a frame difference between the video signals 0F and 2F is characterized in that the difference decreases once every five fields. The pulldown pattern is detected from this regularity. Although the above example discusses a case of 3:2 pulldown, 2:2 pulldown and other pulldown techniques may be used.

Moreover, in the cinema detector 303, OSD-mixed video having a pattern different from the pulldown pattern of the telecine video may be excluded from cinema detection by excluding pixels on which an OSD has been mixed from cinema detection, using the OSD mixing signals S200, S201, and S202. Thus, the accuracy of cinema detection is improved.

The phase comparator 400 detects, in an OSD movement detector 401, whether the OSD has moved or not, and compares the OSD-mixed video with the timing of conversion of the video having a pulldown format.

By way of example, the OSD movement detector 401 compares the OSD mixing signal S200 and the OSD mixing signal S202 delayed for one frame with respect to the OSD mixing signal S200, and can determine that the OSD-mixed location has moved if only one or the other of the signals indicates a location where the OSD has been inserted. The phase comparator 400 needs to make a comparison to determine whether the detection result for the OSD-mixed location of the OSD movement detector 401 and the timing of movement of the OSD-mixed location follow the pulldown pattern output by the cinema detector 303.

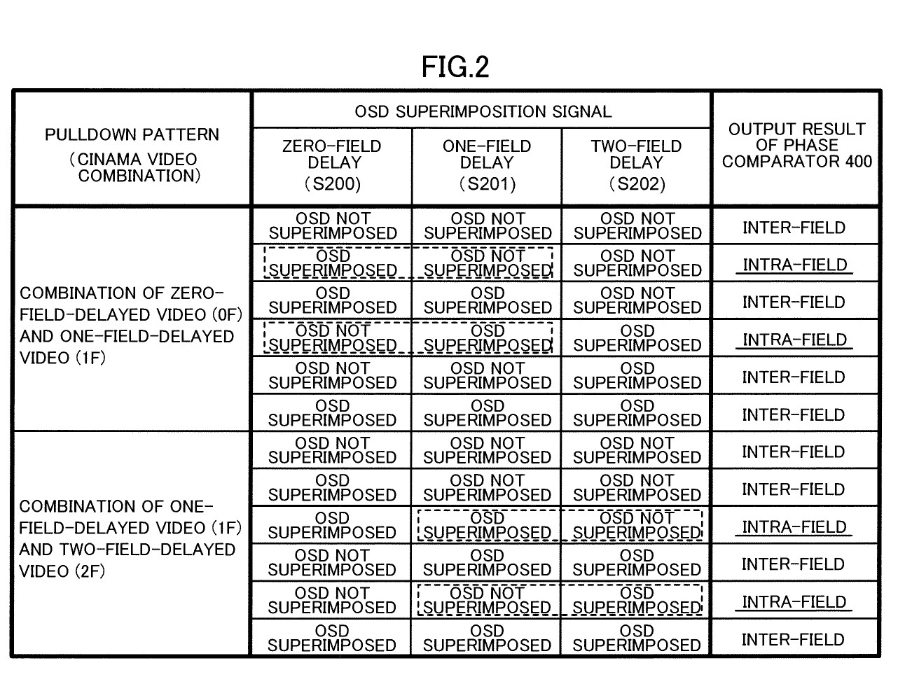

Next, video generation is described referring to FIG. 2. The table of FIG. 2 illustrates relationships among delay combinations of video selected as interpolation lines based on the pulldown pattern detected by the cinema detector 303, the results of the OSD mixing signals S200, S201, and S202, and the output results of the phase comparator 400.

If the pulldown pattern indicates that a combination of video delayed for no fields (0F) and video delayed for one field (1F) generates a frame of video, and if only one of the OSD mixing signal S200 or S201 contains OSD information, it is determined that the OSD has moved, and thus intra-field interpolation is selected. Similarly, if the pulldown pattern indicates that a combination of video delayed for one field (1F) and video delayed for two fields (2F) generates a frame of video, and if only one of the OSD mixing signal S201 or S202 contains OSD information, it is determined that the OSD has moved, and thus intra-field interpolation is selected. Note that, when OSD mixing signals are compared, since these signals are those of an interlaced signal, the center of video is displaced when a comparison is made with an OSD mixing signal delayed for one field. Accordingly, it is enough to make the comparison using video information at an adjacent location. For example, in a case of the OSD mixing signal S200, it is determined that an OSD has not moved if the OSD mixing signal S201 has ODS information either above or under the subject pixel of the OSD mixing signal S200. In addition, when a frame difference between the OSD mixing signals S200 and S202 is investigated, and if it is found that the OSD mixing signals S200 and S202 both have information of OSD mixing, and the OSD mixing signal S201 contains OSD information, then the OSD is continuous over the OSD mixing signals S200, S201, and S202, and moreover, the OSD-mixed locations of the OSD mixing signals S200 and S202 are the same. Accordingly, it may be determined that the OSD has not moved.

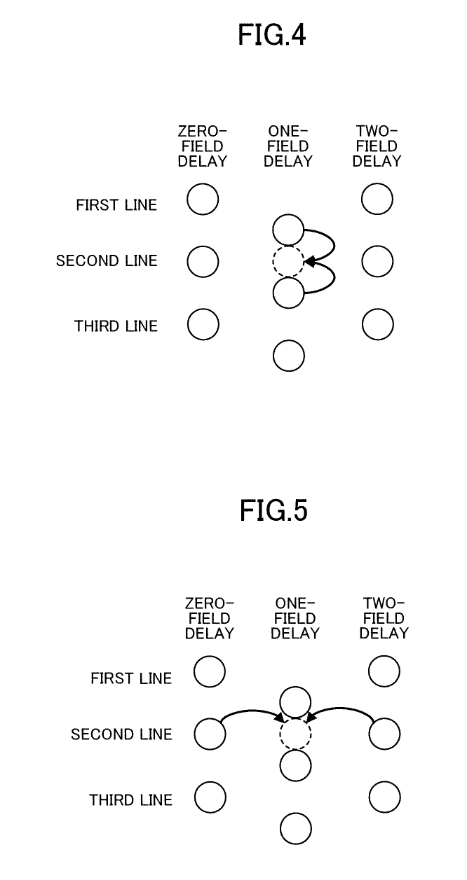

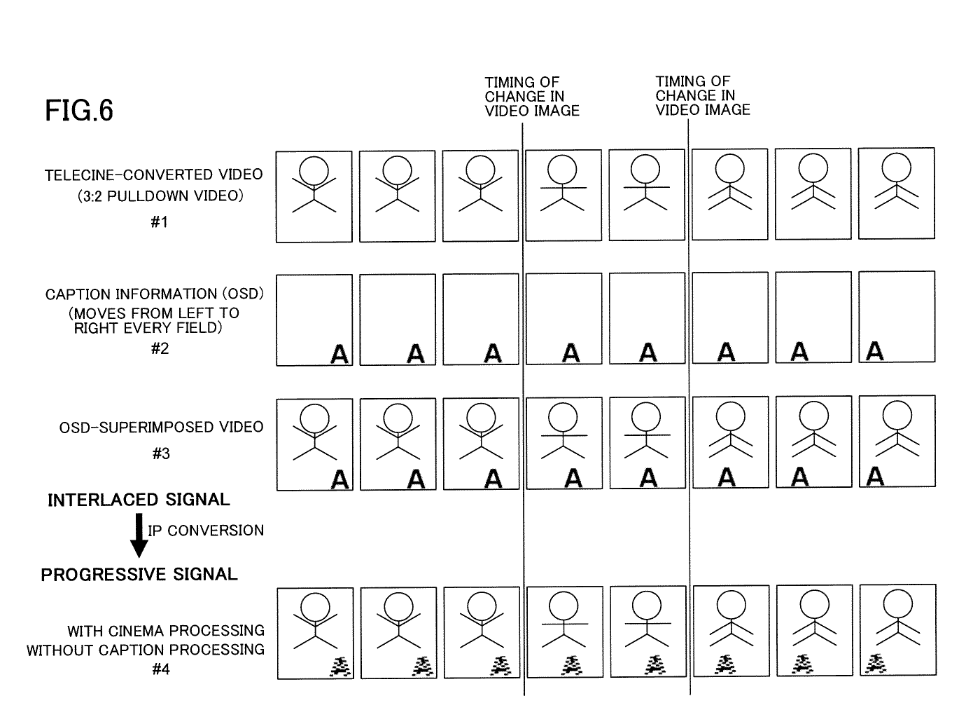

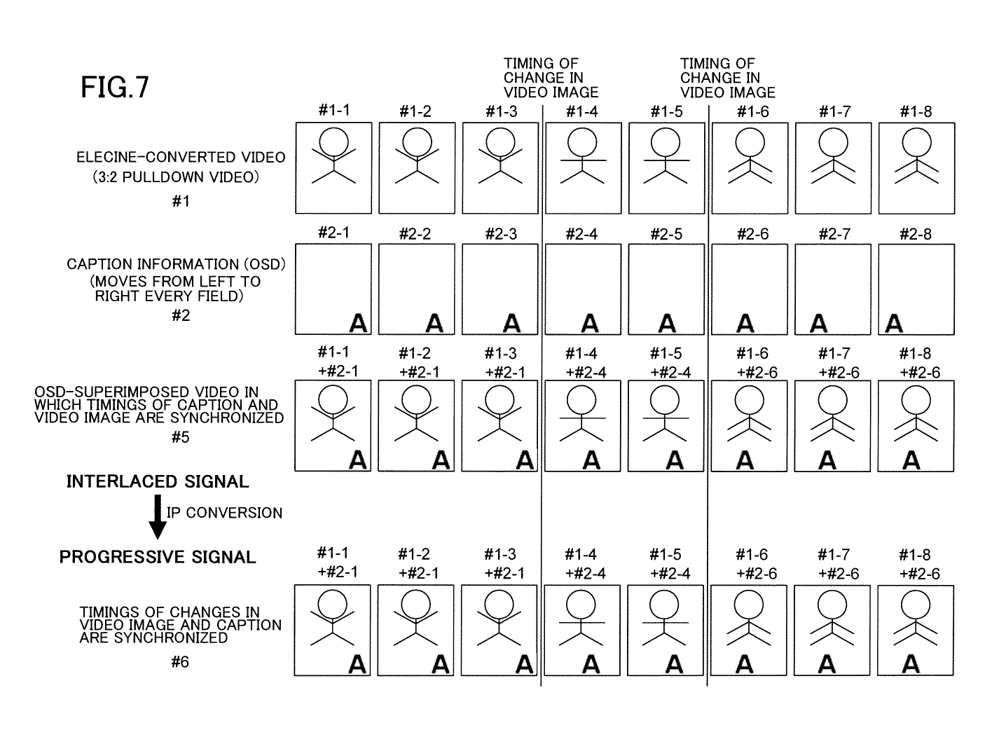

The interpolated pixel generator 500 includes an inter-field data selector 501, an intra-field interpolator 502, and an interpolation data selector 503. The inter-field data selector 501 selects the OSD-mixed video data (0F) or the video data delayed for two fields (2F) based on the pulldown pattern detected by the cinema detector 303, and outputs data for performing inter-field interpolation as shown in FIG. 5. The intra-field interpolator 502 outputs data for intra-field interpolation which uses pixel data of the same field as shown in FIG. 4, from the video data delayed for one field (1F).

The interpolation data selector 503 performs intra-field interpolation on pixels for which the phase comparator 400 determines that the OSD-mixed location has moved, using the intra-field interpolation data output by the intra-field interpolator 502, and performs inter-field interpolation (interpolation using the pulldown pattern) on the other locations, using the inter-field interpolation data output by the inter-field data selector 501.

Although the embodiment described above discusses an example in which the OSD mixing signal S200 is output by the OSD mixer 100, the present invention is not limited thereto, but the OSD mixing signal S200 may be information indicating an OSD insertion location obtained with a microcomputer.

Moreover, although the example has been discussed in which the detection of the pulldown pattern is performed by a determination in the cinema detector 303, the present invention is not limited thereto, but the pulldown pattern may be detected by, for example, a microcomputer etc., and the result thereof may be used.

As described above, according to this embodiment, reduction in video quality is prevented when IP conversion is performed on video images in which a moving OSD, such as a telop which shifts at a timing not following the pulldown pattern of telecine video, is mixed, or in which an OSD, such as a caption which appears and disappears at a timing not following the pulldown pattern, is mixed.

### Second Embodiment

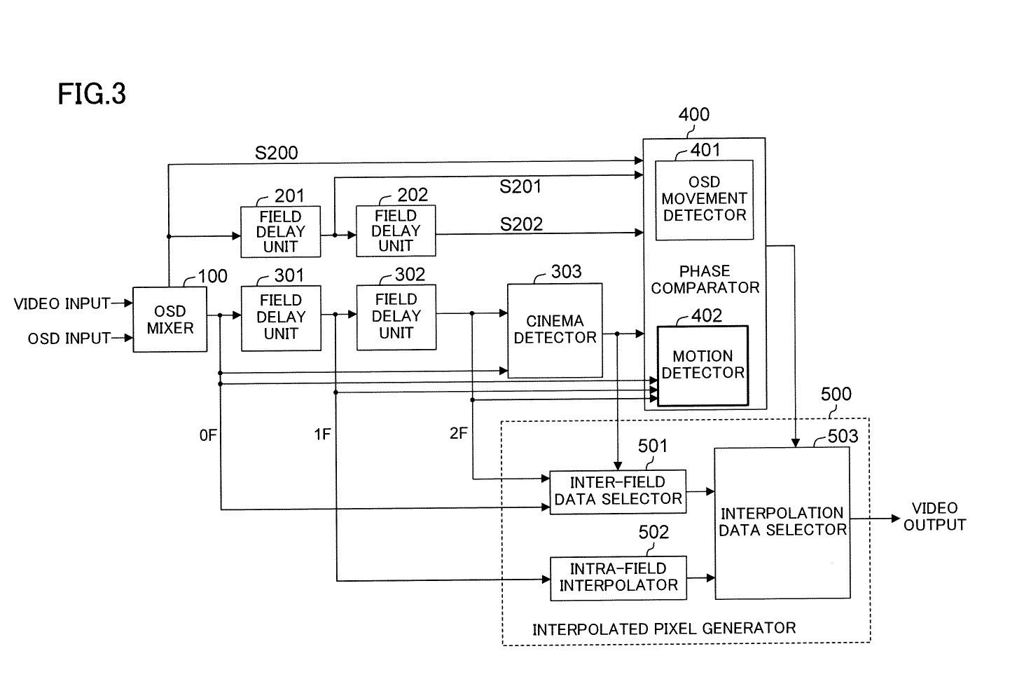

FIG. 3 is a block diagram illustrating a configuration of a video processing device according to the second embodiment. The difference from the video processing device of the first embodiment (FIG. 1) is that a motion detector 402 is provided in the phase comparator 400. The motion detector 402 compares a pixel which at least one of the OSD mixing signal S200, S201, or S202 indicating the OSD-mixed pixels indicates as a subject of OSD mixing, and for which the OSD movement detector 401 has detected that the OSD-mixed pixel has not moved, with an OSD-mixed video image different by at least one field; and if the video images differ, then it is determined that the OSD-mixed video image has changed, and thus the interpolation data selector 503 selects the output data of the intra-field interpolator 502.

For example, if the area of pixels where an OSD is mixed is fixed, and if video which changes at a timing different from that indicated by the pulldown pattern of the input video is input within the area, then the OSD-mixed location does not move, and thus the OSD mixing signals S200 and S202 are the same. Accordingly, the OSD movement detector 401 determines that the movie image has not moved. Thus, the motion detector 402 calculates the difference between the video signal OF output from the OSD mixer 100 and the video signal 2F output from the field delay unit 302 for a location where the OSD movement detector 401 has determined that the OSD has not moved. If the difference is large, it can be determined that the video image of the OSD has changed. In this way, the interpolation data selector 503 selects the data of the intra-field interpolator 502 for a location where the OSD-mixed location has moved, or when the OSD is mixed but the OSD video image has changed. Thus, reduction in image quality of movie in which the OSD is mixed with the telecine movie can be prevented.

Although the above example utilizes the difference between the video signals OF and 2F, other combinations of different-field video images may be used. Thus, even when the subject pixel where the OSD is mixed has not moved, and the OSD is a moving image, reduction in video quality can be prevented.

As described above, this embodiment detects whether the location where an OSD display such as a caption or a telop is mixed with a telecine video has moved or not. In addition, it is determined whether or not there is a change in a video image at the OSD-mixed location by detecting a change in the video image at the OSD-mixed location also for a location where the OSD is not detected to have moved. If the timing of movement of the OSD-mixed location and the timing of change at the OSD-mixed location differ from those indicated by the pulldown pattern of the telecine movie, a video image of an interpolation line is generated in a different manner from the pulldown pattern. Accordingly, even when a changed OSD is mixed, reduction in image quality can be prevented.

The example embodiments of the present invention can be industrially applied to a video processing device in which reduction in image quality of an OSD-mixed region does not occur when IP conversion is performed on video in which an OSD is mixed with a telecine signal. The video processing devices of the present invention are advantageous in that reduction in image quality is reduced on IP conversion of OSD-mixed video, and thus can be expected to be integrated into digital television sets, DVD players, etc.

The present invention is not limited to the described embodiments, but may be embodied in other various forms without departing from its spirit or essential characteristics. The described embodiments are to be considered in all respects only as illustrated and not restrictive. The scope of the invention is, therefore, indicated by the appended claims rather than by the foregoing description. All changes and modifications which come within the meaning and range of equivalency of the claims are to be embraced within their scope.

What is claimed is:

1. A video processing device for converting an interlaced signal into a progressive signal, comprising:
an OSD mixer configured to mix an OSD display with the interlaced signal;
a cinema detector configured to detect a pulldown pattern by comparing video images of different fields;
a phase comparator configured to compare a timing of change in the OSD display and a timing of change in a cinema video image based on an OSD mixing signal indicating an OSD-mixed location in the OSD mixer and on the pulldown pattern detected in the cinema detector; and
an interpolated pixel generator configured to generate a new pixel between lines of the interlaced signal by an interpolation method based on a detection result in the cinema detector and on a comparison result in the phase comparator.

2. The video processing device of claim 1, wherein
the interpolated pixel generator includes
an intra-field interpolator configured to generate a pixel of an interpolation line from pixel data of a same field,
an inter-field data selector configured to select a pixel of another field based on pulldown information, which is the detection result in the cinema detector, and
an interpolation data selector configured to select an output result of the intra-field interpolator or a selection result of the inter-field data selector.

3. The video processing device of claim 1, wherein
the interpolated pixel generator includes an interpolation data selector, and
the interpolation data selector makes a selection based on the comparison result in the phase comparator.

4. The video processing device of claim 1, wherein
the phase comparator includes an OSD movement detector configured to detect movement of an OSD by making a comparison with an OSD mixing signal having a different field delay by at least one field.

5. The video processing device of claim 4, wherein
the phase comparator includes a motion detector configured to investigate a difference between video images of fields different by at least one field from each other at a location where the OSD movement detector determines that the OSD-mixed location has not moved.

6. The video processing device of claim 1, wherein
the cinema detector excludes the OSD-mixed location from cinema detection.
